(19) United States
(12) Patent Application Publication
(10) Pub. No.: US 2011/0026733 A1
(43) Pub. Date: Feb. 3, 2011

(54) DEVICE FOR CANCELLING BACKGROUND NOISE AND METHOD THEREOF

(75) Inventors: Hai LI, Shenzhen (CN); Kunping Xu, Shenzhen (CN); Yun Yang, Shenzhen (CN); Wei Feng, Shenzhen (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BYD COMPANY LIMITED, Shenzhen (CN)

(21) Appl. No.: 12/841,074

(22) Filed: Jul. 21, 2010

(30) Foreign Application Priority Data
Jul. 29, 2009 (CN) 200910109073.3

(51) Int. Cl. H04B 15/00

(52) U.S. Cl. 381/94.1

(57) ABSTRACT

A method for cancelling background noise of an audio device comprises determining characteristic values of an audio signal to construct a characteristic signal reflecting a change trend of the audio signal, multiplying the determined characteristic signal with the audio signal to construct a multiplication signal, and amplifying the multiplication signal.

### CROSS-REFERENCE TO RELATED APPLICATION

This application claims foreign priority benefits under 35 U.S.C. §119 of Chinese Patent Application Serial No. 200910109073.3, filed on Jul. 29, 2009, the content of which is incorporated herein by reference in its entirety.

### TECHNICAL FIELD

Exemplary embodiments of the present invention generally relate to an audio device, and in particular, relate to a device for cancelling background noise and method thereof.

### BACKGROUND

In many communication systems, such as hands-free mobile phones, hearing aids, speech recognition systems, and voice control systems, it is critical to obtain desired speech signals from collected audio signals which may often be corrupted by a considerable amount of background noise signals. The high amount of background noise in a moving vehicle, for example, may render a speech communication system worthless.

Since background noise signals have similar characteristics as speech signals, many of the noise cancellation devices may discriminate speech signals from noise signals by comparing the collected signals with a predetermined noise threshold. Nevertheless, the noise may not be suppressed from the speech signals when the noise level suddenly increases or decreases. On the other side, the speech signals that are smaller than the predetermined noise threshold may possibly be lost.

### BRIEF SUMMARY

According to one exemplary embodiment of the invention, a method for cancelling background noise of an audio device comprises determining characteristic values of an audio signal to construct a characteristic signal reflecting a change trend of the audio signal, multiplying the determined characteristic signal with the audio signal to construct a multiplication signal and amplifying the multiplication signal.

According to one exemplary embodiment of the invention, a device for cancelling background noise comprises a detecting unit configured to determine characteristic values of an audio signal to construct a characteristic signal reflecting a change trend of the audio signal. The device further comprises a multiplying unit configured to multiplying the characteristic signal with the audio signal to construct a multiplication signal and an amplifying unit configured to amplify the multiplication signal.

According to one exemplary embodiment of the invention, a method for cancelling background noise of an audio device comprises determining characteristic values of an audio signal to construct a characteristic signal reflecting a change trend of the audio signal, multiplying the determined characteristic signal with the audio signal to construct a multiplication signal and amplifying the multiplication signal. Steps of determining the characteristics of the audio signal, multiplying the determined characteristic signal with the audio signal to construct a multiplication signal and amplifying the multiplication signal are performed by one or more circuits configured to determine characteristic values of an audio signal to construct a characteristic signal reflecting a change trend of the audio signal, multiply the determined characteristic signal with the audio signal to construct a multiplication signal and amplify the multiplication signal.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIG. 1 is a flow chart illustrating a method of cancelling background noise according to one exemplary embodiment of the present invention;

FIG. 2 illustrates a block diagram of a device for cancelling background noise according to one exemplary embodiment of the present invention;

FIG. 3 illustrates a block diagram of a device for cancelling background noise according to another exemplary embodiment of the present invention;

FIG. 4 illustrates a schematic diagram of a signal collecting unit according to one exemplary embodiment of the present invention;

FIG. 5 illustrates a schematic diagram of a pre-amplifying unit according to one exemplary embodiment of the present invention;

FIG. 6 illustrates a schematic diagram of a detecting unit according to one exemplary embodiment of the present invention;

FIG. 7 illustrates a schematic diagram of a peak suppression unit according to one exemplary embodiment of the present invention;

FIG. 8 illustrates a schematic diagram of a multiplying unit according to one exemplary embodiment of the present invention; and

FIG. 9 illustrates a schematic diagram of an amplifying unit according to one exemplary embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, a number of components or objects may be described herein in the singular, plural or as being “at least one” or “one or more.” It should be understood, however, that notwithstanding any particular quantity with which a component or object may be described herein, unless explicitly stated otherwise, the component or object may be in any of a number of different quantities, from the singular to the plural. Like numbers refer to like elements throughout.

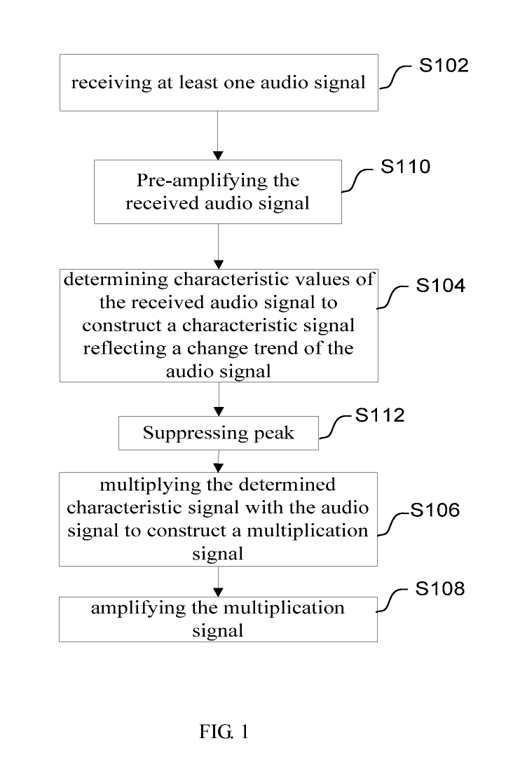

FIG. 1 is a flow chart illustrating a method of cancelling background noise for a device according to one exemplary embodiment of the present invention (“exemplary” as used herein referring to “serving as an example, instance or illustration”). Referring to FIG. 1, at least one audio signal, such as audio signal(s) picked up by a microphone, is received by a signal collecting unit at step S102. The audio signals may be vocal signals, and may include speech signals with noise signals.

To discriminate and cancel the noise signals from the speech signals, the received audio signals are passed to a detecting unit through the signal collecting unit, and are detected and processed at step S104. The received signals may comprise speech signals and noise signals. Characteristic values of the received audio signals may be determined as or after the detection and the processing to construct a characteristic signal reflecting a change trend of the audio signal. In one exemplary embodiment, the speech and noise signal may be associated with characteristics of which the speech signal typically exhibit large values, while the noise signal typically exhibit small values. For example, to make a phone call in an environment with a noise level of 85 db, the average characteristic value of speech signal is about 10˜30 mv, the average characteristic value of noise signal is below 5 mv.

At step S106, multiplications between the audio signals and the characteristic signals may be performed by a multiplying unit. After the multiplication, the product of the voice signal and its respective, associated characteristic signal is larger than that of the noise and its characteristic signal. In this regard, the discrimination level between the speech signals and the noise signals may be greatly increased. The results of the multiplication may be amplified by an amplifying unit at step S108.

In one exemplary embodiment, an additional step S110 may be performed after the audio signals have been received. At this step, the received audio signals may be pre-amplified before input to the detecting unit and the multiplying unit.

Additionally or alternatively, the values of the characteristics signals generated by the detecting unit may be input to a peak suppression unit, which may suppress at least a portion of the respective values at step S112. The peak suppressed characteristic signal may then be multiplied with their respective, associated audio signals at step S106.

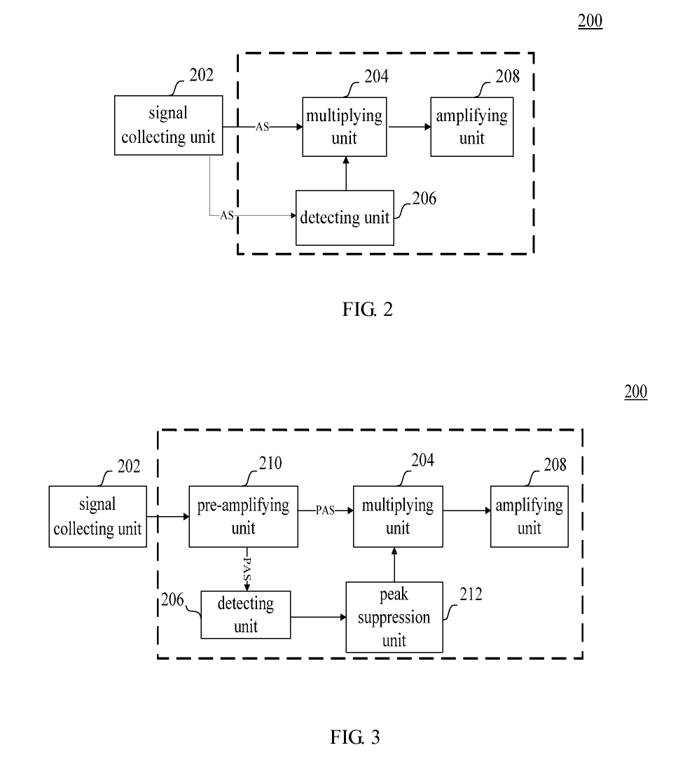

FIG. 2 illustrates a block diagram of a device 200 for canceling background noise according to one exemplary embodiment of the present invention. As shown in FIG. 2, the device 200 includes a signal collecting unit 202, a multiplying unit 204, a detecting unit 206, and an amplifying unit 208. In this exemplary embodiment, the signal collecting unit 202 may be configured to receive audio signals AS (e.g., audio signals picked up by a microphone), and may be configured to output the received audio signals AS respectively to the multiplying unit 204 and the detecting unit 206. The detecting unit 206 may be configured to determine characteristic values of the received audio signals AS to construct a characteristic signal. In one exemplary embodiment, the detecting unit 206 may be configured to detect an effective value of the received audio signals AS to construct an average power signal of the audio signal. The multiplying unit 204 may be configured to multiply the average power signal with the received audio signals AS. In another exemplary embodiment, the detecting unit 206 may be configured to detect peak values to construct a peak change signal reflecting a change trend of the peak value of the audio signal. The multiplying unit 204, then, may be configured to multiply the received audio signals AS with peak change signal.

Since the speech signal may correspond to large characteristic values and the noise signal may correspond to small characteristic values, the discrimination level between the speech signals and the noise signals may be greatly increased as a result of the multiplication. After the multiplying unit 204 performs the multiplication operation, the multiplying unit 204 may be configured to output the results of the multiplication operation to an amplifying unit 208 configured to further increase the discrimination level between the speech signals and the noise.

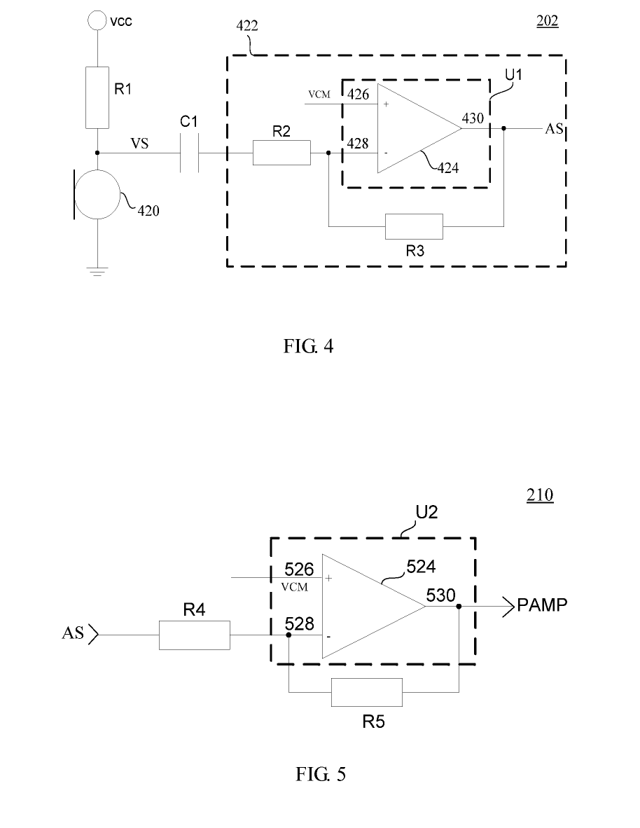

FIG. 3 illustrates a block diagram of a device for cancelling background noise according to another exemplary embodiment of the present invention. FIG. 3 illustrates a similar device described in FIG. 2, but further including an optional pre-amplifying unit 210 and a peak suppression unit 212. The pre-amplifying unit 210 may be configured to pre-amplify the audio signals that are received from the signal collecting unit 202 and output the pre-amplified signals PAS respectively to the multiplying unit 204 and the detecting unit 206. The peak suppression unit 212 may be configured to receive the characteristic signal from the detecting unit 206 and suppress peak values of the characteristic signal. The peak suppression unit 212 may then be configured to output the peak suppressed characteristic signal to the multiplying unit 204, which may be configured to multiply the peak suppressed characteristic signal with the pre-amplified signals PAS therein. Example circuits and operation of each unit are described in detail in FIGS. 4-9.

FIG. 4 illustrates a schematic diagram of a signal collecting unit 202 according to one exemplary embodiment of the present invention. The signal collecting unit 202 may include a resistor R1, a microphone 420, a capacitor C1 and a voltage follower circuit 422. In one exemplary embodiment, the resistor R1 may be a bias resistor. The capacitor C1 may be a DC blocking capacitor. As shown, a first terminal (not numbered) of the microphone 420 is coupled to the resistor R1 which is in turn connected to a voltage source VCC. A second terminal of the microphone 420 is connected to the ground. The first terminal of the microphone 420 is also coupled to the capacitor C1 which is in turn connected to the voltage follower circuit 422. The voltage follower circuit 422 may include a resistor R2, a resistor R3, and a first operational amplifier circuit U1. The first operational amplifier circuit U1 includes an operational amplifier 424 having a positive input 426 coupled to a common mode voltage VCM, a negative input 428, and an amplifier output 430. The negative input 428 is coupled to the capacitor C1 via the resistor R2, at a different terminal from the terminal coupled to the microphone 420. The amplifier output 430 is connected back to the negative input 428 through the resistor R3.

In operation, audio signals VS are collected from the microphone 420. Only AC signals in the vocal signals may pass through to the voltage follower circuit 422, while the DC bias may be blocked by the capacitor C1. Audio signals appear at the amplifier output 430, after the capacitor C1 and the operational amplifier U1.

FIG. 5 illustrates a schematic diagram of a pre-amplifying unit 210 according to one exemplary embodiment of the present invention. The pre-amplifying unit 210 may include a resistor R4, and a second operational amplifier circuit U2. The second operational amplifier circuit U2 includes an operational amplifier 524 having a positive input 526 coupled to a common mode voltage VCM, a negative input 528, and an amplifier output 530. A first terminal (not numbered) of the resistor R4 is coupled to the signal collecting unit 202. A second terminal (not numbered) of the resistor R4 is coupled to the negative input 528. The amplifier output 530 is connected back to the negative input 528 through a resistor R5.

In operation, the pre-amplifying unit 210 may be configured to detect a weak signal and strengthen it for further amplification. The pre-amplifying unit 210 may be configured to receive the audio signals AS from the signal collecting unit 202. The second operational amplifier circuit U2 may be configured to produce pre-amplified audio signal PAMP at the amplifier output 530. In various exemplary embodiments, the gain may be between four and five.

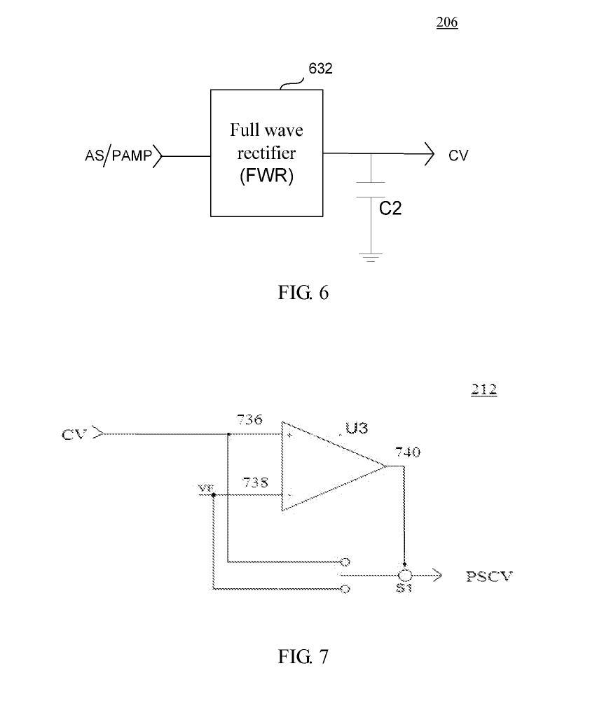

FIG. 6 illustrates a schematic diagram of a detecting unit 206 according to one exemplary embodiment of the present invention. The detecting unit 206 may include a full wave rectifier (FWR) 632 and a capacitor C2. The FWR may be configured to receive audio signals from the signal collecting unit 202, or receive the pre-amplified audio signal from the pre-amplifying unit 210, and may be coupled to the capacitor C2, which is in turn connected to the ground.

In operation, the FWR 632 is employed in detection of the audio signals. The audio signals may or may not be amplified before detection. As described above, the input of the FWR 632 may be the audio signals AS at the amplifier output 430 of the signal collecting unit 202 as shown in FIG. 2, or may be the pre-amplified voltages PAMP at the amplifier output 530 of the pre-amplifying unit 210 as illustrated in FIG. 3. The FWR 632 may be configured to rectify the AC voltages input, such as the audio signals or the pre-amplified audio signal, to deliver a form of DC output. To produce a constant DC output, a filter capacitor may be applied. In this exemplary embodiment, the capacitor C2, placed at the output of the FWR 632, may be configured to function as the filter to pass the rectified signals. The filter capacitor C2 in combination with the FWR 632 may be configured to detect effective value of the input signals and output an average power signal to next stage, or may be configured to determine peak values of the input signals and output a peak change signal, and accordingly may be referred to as a characteristic signal.

FIG. 7 illustrates a schematic diagram of a peak suppression unit 212 according to one exemplary embodiment of the present invention. The peak suppression unit 212 may include a comparator U3 having a positive input 736 configured to receive characteristic signal from the detecting unit 206 as described above, a negative input 738 coupled to a pre-determined peak suppression voltage VF, and an output 740 coupled to a switch S1.

In operation, when the positive input 736 (the characteristic signal CV) are at a higher voltage than the negative input 738 coupled to the pre-determined peak suppression voltage VF, the comparator U3 is configured to control the switch S1 switch to the negative input 738. On the other side, when the positive input 736 is at a lower voltage than the negative input 738, the comparator U3 is configured to control the switch S1 switch to the positive input 736. In this manner, the peak voltages may be suppressed. The peak suppressed characteristic signal may be accordingly referred to as peak suppressed characteristic signal PSCV.

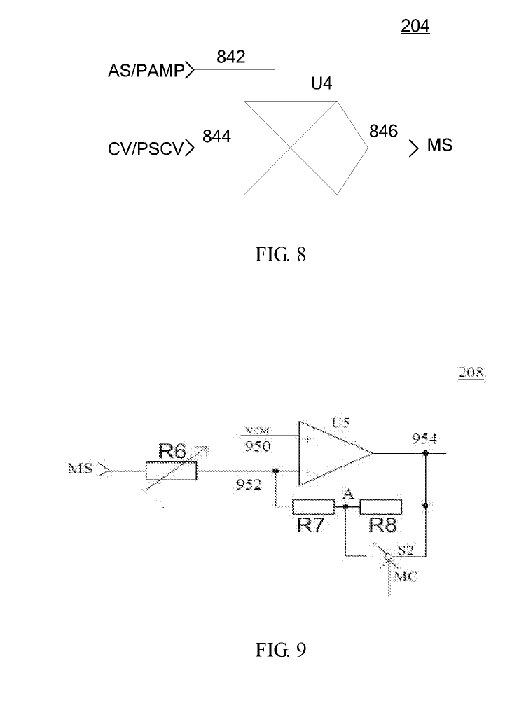

FIG. 8 illustrates a schematic diagram of a multiplying unit 204 according to one exemplary embodiment of the present invention. The multiplying unit 204 includes a first input 842, a second input 844, and an output 846. Depending on various applications, the first input 842 may be coupled to the output of the signal collecting unit 202 or the output of the pre-amplifying unit 210. The second input 844 may be coupled to the output of the detecting unit 206 or the output of the peak suppression unit 212. In operation, the multiplying unit 212 may be configured to perform a multiplication operation. The output 846 may be a multiplication product of the first input 842, the second input 844 and a coefficient, and may be accordingly referred to as a multiplication signal MS. In various exemplary embodiments, the coefficient may be a pre-determined factor.

FIG. 9 illustrates a schematic diagram of an amplifying unit 208 according to one exemplary embodiment of the present invention. The amplifying unit 208 may include an operational amplifier U5 having a positive input 950 coupled to a common mode voltage VCM, a negative input 952 coupled to a first terminal of the resistor R6, and an output 954. A second terminal of the resistor R6 may be coupled to the multiplication signal MS, and may thus be configured to receive the output signals from the multiplying unit 204. The output 954 is connected back to the negative input 952 through a resistor R7 and a resistor R8. A switch S2 is connected in parallel with the resistor R8 between the output 954 and a node A placed between the resistor R7 and the resistor R8.

In operation, the resistor R6 may be a variable resistor that may be configured to determine the input resistance of the operational amplifier U5. The output resistance may be determined by a mode control signal MC. When the switch S2 is closed in response to the mode control signal MC, the output resistance may be (R7+R8). Accordingly, the gain of the operational amplifier U5 may be (R7+R8)/R6. In another exemplary embodiment, the gain may be R7/R6 when the switch S2 is open. In other words, the gain of the operational amplifier U5 may be adjusted by the resistance of the variable resistor R6 and the mode control signal MC, according to various applications. By adjusting the gain of the operational amplifier U5, the noise signals may be strongly attenuated. The variable gain may also greatly amplify the speech signals.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method for cancelling background noise of an audio device, comprising:
determining characteristic values of an audio signal to construct a characteristic signal reflecting a change trend of the audio signal;
multiplying the determined characteristic signal with the audio signal to construct a multiplication signal; and
amplifying the multiplication signal.

2. The method of claim 1, further comprising pre-amplifying the audio signal.

3. The method of claim 1, wherein the step of determining characteristic values of an audio signal to construct a characteristic signal reflecting a change trend of the audio signal further comprises detecting effective values of the audio signal to construct an average power signal of the audio signal.

4. The method of claim 3, further comprises multiplying the constructed average power signal with the audio signal to construct a multiplication signal.

5. The method of claim 1, wherein the step of determining characteristic values of an audio signal further comprises detecting peak values of the audio signal to construct a peak change signal reflecting a change trend of the peak values of the audio signal.

6. The method of claim 1, further comprising performing signal peak suppression of the constructed characteristic signal.

7. A device for cancelling background noise, the device comprising:
a detecting unit configured to determine characteristic values of an audio signal to construct a characteristic signal reflecting a change trend of the audio signal;
a multiplying unit configured to multiplying the characteristic signal with the audio signal to construct a multiplication signal; and
an amplifying unit configured to amplify the multiplication signal.

8. The device of claim 7 further comprising a pre-amplifier unit configured to receive an audio signal and pre-amplify the received audio signal.

9. The device of claim 7, wherein the detecting unit is configured to detect an effective value of the audio signal to construct an average power signal of the audio signal.

10. The device of claim 7, wherein the detecting unit is configured to detect peak values of the audio signal to construct a peak change signal reflecting a change trend of the peak value of the audio signal.

11. The device of claim 7, wherein the detecting unit comprises:
a rectifier, configured to receive at least one input signal, rectify the received input signal and output a rectified signal; and
a capacitor coupled to an output of the rectifier, which in turn is grounded, to filter a part of the rectified signal.

12. The device of claim 11, wherein the rectifier comprises a full wave rectifier.

13. The device of claim 7 further comprising a peak suppression unit, wherein the peak suppression unit is configured to receive the characteristic signal and perform a peak suppression of the characteristic signal.

14. A method for cancelling background noise of an audio device, comprising:
determining characteristic values of an audio signal to construct a characteristic signal reflecting a change trend of the audio signal;
multiplying the determined characteristic signal with the audio signal to construct a multiplication signal; and
amplifying the multiplication signal,
wherein determining the characteristics of the audio signal to construct a characteristic signal reflecting a change trend of the audio signal, multiplying the determined characteristic signal with the audio signal to construct a multiplication signal and amplifying the multiplication signal are performed by one or more circuits configured to determine characteristic values of an audio signal to construct a characteristic signal reflecting a change trend of the audio signal, multiply the determined characteristic signal with the audio signal to construct a multiplication signal and amplify the multiplication signal.

15. The method of claim 14, further comprising pre-amplifying the audio signal.

16. The method of claim 14, wherein the step of determining characteristic values of an audio signal to construct a characteristic signal reflecting a change trend of the audio signal further comprises detecting effective values of the audio signal to construct an average power signal of the audio signal.

17. The method of claim 16, further comprises multiplying the constructed average power signal with the audio signal to construct a multiplication signal.

18. The method of claim 14, wherein the step of determining characteristic values of an audio signal further comprises detecting peak values of the audio signal to construct a peak change signal reflecting a change trend of the peak values of the audio signal.

19. The method of claim 14, further comprising performing signal peak suppression of the constructed characteristic signal.
